(19) United States
(12) Patent Application Publication
(10) Pub. No.: US 2004/0190847 A1
(43) Pub. Date: Sep. 30, 2004

(54) High dispersion, wide band dispersion compensating optical fiber

(76) Inventors: Scott R. Bickham, Corning, NY (US); Joohyun Koh, Painted Post, NY (US); Venkatapuram S. Sudarshanam, Big Flats, NY (US)

Correspondence Address: CORNING INCORPORATED, SP-TI-3-1, CORNING, NY, 14831

(21) Appl. No.: 10/794,879

(22) Filed: Mar. 5, 2004

Related U.S. Application Data
(60) Provisional application No. 60/458,046, filed on Mar. 27, 2003.

(51) Int. Cl. G02B 6/22

(52) U.S. Cl. 385/127

(57) ABSTRACT

A dispersion compensating fiber that includes a segmented core having a refractive index profile with a core segment having a Δ₁% greater than 2.0%, a clad layer surrounding and in contact with the core and having a refractive index profile, wherein the refractive index profiles are selected to provide a total dispersion at a wavelength of about 1550 nm of less than or equal to about −177 ps/nm/km, and a total dispersion slope at a wavelength of about 1550 nm of less than or equal to about −2.0 ps/nm²/km. The refractive index profiles are further selected to provide a kappa value, defined as the total dispersion at 1550 nm divided by the dispersion slope at 1550 nm, of greater than or equal to about 67 nm.

### CROSS-REFERENCE TO RELATED APPLICATIONS

This application claims the benefit of, and priority to U.S. Provisional Application Serial No. 60/458,046 filed on Mar. 27, 2003.

### BACKGROUND OF THE INVENTION

1. Field of the Invention

The present invention relates generally to optical fiber, and more particularly to dispersion compensating optical fiber and transmission lines including combinations of non-zero dispersion shifted optical fiber, utilized as transmission fiber, and dispersion compensating optical fiber.

2. Technical Background

Increased demand for higher bit transmission rates has resulted in a large demand for optical transmission systems that can control and minimize dispersion effects. A linear analysis of common optical transmission systems indicates that while optical transmission systems can tolerate approximately 1,000 ps/nm residual dispersion at 10 Gbit/second, these systems tolerate only about 62 ps/nm residual dispersion at a higher transmission rate of about 40 Gbit/second. Therefore, it is of the utmost importance to accurately control the dispersion for such high bit-rate optical transmission systems. Moreover, dispersion control becomes increasingly important as the transfer rate increases. In addition to the need to accurately control dispersion, it is also desirable to compensate for dispersion slope of a transmission fiber as transmission rates approach 40 Gbit/second.

Various solutions have been proposed to achieve the low dispersion and dispersion slope values required for compensating non-zero dispersion shifted fibers, including: photonic crystal fibers, higher order mode dispersion compensation, dispersion compensating gratings, and dual fiber dispersion compensating techniques. Each of these solutions has significant drawbacks associated therewith.

Photonic crystal fibers are designed to have a large negative dispersion and a negative dispersion slope that are close to those required for compensating non-zero dispersion shifted fibers. However, photonic crystal fibers have significant drawbacks including a relatively small effective areas that generally lead to unacceptably high splice losses and hence require the use of a transition fiber to reduce splice losses. In addition, due to the very nature of photonic crystal fibers, i.e. glass/air interfaces in the core of the fiber, the related attenuation is unacceptable in the transmission window of interest due to the residual absorption of the 1380 nm water peak. Further, photonic crystal fibers are significantly difficult to manufacture on a large scale and may, therefore, be expensive. An example of a photonic crystal fiber may be found in U.S. Pat. No. 6,445,862.

Higher order mode dispersion compensation relies on the dispersion properties of higher order modes in the fiber. It has been demonstrated that higher order modes, e.g. LP₀₂ and LP₁₁, have higher negative dispersions and dispersion slopes than the fundamental mode LP₀₁. Higher order dispersion compensation typically relies on the conversion of a transmitted fundamental mode to one of the higher order modes via a mode converter device. Subsequently, this higher order mode is propagated in a Higher Order Mode (HOM) fiber that supports that higher order mode. After a finite distance, the higher order mode may be converted back to the fundamental mode via a second mode converting device. Problems associated with HOM dispersion compensation solutions include inefficient mode converters, splicing problems and losses, and the difficulty of producing HOM fibers that allow higher order mode transmission while resisting coupling to the fundamental mode. An example of a HOM fiber and dispersion compensating module may be found in WO 01/59496.

Dispersion compensating gratings are utilized to achieve a required differential group delay via chirped gratings. Techniques utilizing dispersion compensating gratings have been shown to be useful only for narrow bands, as these techniques typically suffer from dispersion and dispersion slope ripple when the required grating length becomes large.

Dual fiber dispersion compensating solutions for non-zero dispersion shifted fibers are similar to the dispersion compensating gratings techniques described above in that the dispersion compensation and the slope compensation are de-coupled and separately treated. Typically, dual fiber dispersion compensating techniques include the use of a dispersion compensating fiber followed by a dispersion slope compensating fiber. U.S. 2002/0102084 describes one such dual fiber dispersion compensating technique. Such solutions require the use of a dispersion slope compensating fiber that compensates for a relatively small dispersion slope. Extensive profile modeling of optical fibers has resulted in well-established correlations between dispersion slope, effective area, and bend sensitivity. By increasing the role played by waveguide dispersion in a given fiber, it is possible to decrease the slope and even create a negative slope in some cases. However, as the effective area is decreased, the bend sensitivity of the fiber is increased. Effective area of the fiber can be increased at the expense of further degradation of the bend sensitivity. Decreasing the dispersion slope, or making the dispersion slope negative, results in working very close to the cut-off wavelength of the fundamental mode, which in turn makes the fiber more bend sensitive, and generally may result in greater signal loss at long wavelengths, i.e., wavelengths greater than 1560 nm. As a result of these relationships, it is difficult to manufacture compensating fibers that easily compensate both dispersion and dispersion slope.

Heretofore, the most viable broad band commercial technology available to reduce or eliminate dispersion has been dispersion compensating fiber modules. As dense wavelength division multiplexing deployments increase to 16, 32, 40 and more channels, broadband dispersion compensating products are desired. Telecommunication systems presently include single-mode optical fibers designed to enable transmission of signals at wavelengths around 1550 nm in order to utilize the effective and reliable erbium-doped fiber amplifiers currently available.

With continuing interest in higher bit-rate information transfer, i.e. greater than 40 Gbit/second, ultra-long reach systems, i.e., systems greater than 100 km in length, and optical networking, it has become imperative to employ dispersion compensating fibers in networks that carry data on non-zero dispersion shifted fibers. The combination of the early versions of dispersion compensating fibers with non-zero dispersion shifted fibers effectively compensated dispersion at only one wavelength. However, higher bit-rates, longer reaches and wider bandwidths require dispersion slope to be more precisely compensated across broad bands. Consequently, it is desirable for the dispersion compensating fiber to have dispersion characteristics such that its dispersion and dispersion slope are matched to that of the transmission fiber.

An example of the application of dispersion compensating fibers are those used to compensate LEAF® fiber as manufactured and marketed by Corning Incorporated of Coming, N.Y. Conventional dispersion compensating fibers operate in the L-band range (1570 nm to 1610 nm) for compensating positive dispersion fibers such as LEAF transmission fiber. The required length of dispersion compensating fiber required to compensate for an approximately 100 km length of LEAF would be approximately 5.3 km. However, due to fiber process variations, this length can be as much as 7.8 km. The total insertion loss for a dispersion compensating module utilizing dispersion compensating fiber as described above, is typically about 6 dB, the main contribution to which is the attenuation of the dispersion compensating fiber itself. As the length of dispersion compensating fiber required to compensate for the dispersion of the transmission fiber increases, so does the attenuation associated therewith and contributed thereby. In order to overcome the insertion loss, the dispersion compensating fiber may be optically pumped to obtain broadband optical gain. Based on the stimulated Raman scattering effect, this pumping scheme can generate up to approximately 10 dB of gain before other optical impairments drive down the advantages.

Thus, there is a need for a dispersion compensating fiber of reduced length, that adequately compensates for the dispersion of a positive dispersion transmission fiber. There is a further need for a dispersion compensating fiber requiring a significantly reduced amount of Raman pump power for regenerating the signal associated with the insertion loss of the dispersion compensating fiber. Moreover, there is a need for reducing nonlinear impairments within a Raman pumped dispersion compensating fiber.

### SUMMARY OF THE INVENTION

Definitions:

The following definitions and terminology are commonly used in the art.

Refractive index profile—the refractive index profile is the relationship between the refractive index (Δ%) and the optical fiber radius (as measured from the centerline of the optical fiber) over a selected segment of the core.

Segmented core—a segmented core is one that has multiple segments in the physical core, such as a first and a second segment, for example, any two of the following: a central core segment, a moat segment, and a ring segment. Each segment has a respective refractive index profile and a maximum and minimum refractive index therein.

Radii—the radii of the segments of the core are defined in terms of the index of refraction of the material of which the segment is made. A particular segment has a first and a last refractive index point. A central segment has an inner radius of zero because the first point of the segment is on the centerline. The outer radius of the central segment is the radius drawn from the waveguide centerline to the last point of the refractive index of the central segment. For a segment having a first point away from the centerline, the radius of the waveguide centerline to the location of its first refractive index point is the inner radius of that segment. Likewise, the radius from the waveguide to centerline to the location of the last refractive index point of the segment is the outer radius of that segment.

Effective area—the effective area is defined as:

A_{eff}=2π(∫E²rdr)²/(∫E⁴rdr),

wherein the integration limits are 0 to ∞, and E is the electric field associated with the propagated light as measured at 1550 nm.

Relative refractive index percent Δ%—the term Δ% represents a relative measure of refractive index defined by the equation:

Δ%=100×(nᵢ²−n_{c}²)/2nᵢ²

where Δ% is the maximum refractive index of the index profile segment denoted as i, and n_{c}, the reference refractive index, is taken to be the refractive index of the clad layer. Every point in the segment has an associated relative index.

Alpha-profile—the term alpha-profile refers to a refractive index profile of the core expressed in terms of Δ(b)% where b is the radius, and which follows the equation:

Δ(b)%=[Δ(b₀)(1−[αb−b₀α/(b₁−b₀)^{α}]×100,

where b₀ is the maximum point of the profile of the core and b₁ is the point at which Δ(b)% is zero and b is the range of bᵢ is the range of bᵢ less than or equal to b less than or equal to b_{f}, where Δ% is defined above, bᵢ is the initial point of the alpha-profile, b_{f} is the final point of the alpha-profile, and alpha is an exponent which is a real number. The initial and final points of the alpha profile are selected and enter into the computer model. As used herein, if an alpha-profile is proceeded by a step index profile, the beginning point of the α-profile is the intersection of the α-profile and the step profile. In the model, in order to bring out a smooth joining of the α-profile with the profile of the adjacent profile segment, the equation is written as:

Δ(b)%=[Δ(b_{α})+[Δ(b₀)−Δ(b_{α})]{1−[αb−b₀α/(b₁−b₀)]^{α}}]100,

where b_{α} is the first point of the adjacent segment.

Pin array macro-bending test—this test is used to test compare relative resistance of optical fibers to macro-bending. To perform this test, attenuation loss is measured when the optical fiber is arranged such that no induced bending loss occurs. This optical fiber is then woven about the pin array and attenuation again measured. The loss induced by bending is the difference between the two attenuation measurements and dB. The pin array is a set of ten cylindrical pins arranged in a single row and held in a fixed vertical position on a flat surface. The pin spacing is 5 mm, center-to-center. The pin diameter is 0.67 mm. The optical fiber is caused to pass on opposite sides of adjacent pins. During testing, the optical fiber is placed under a tension sufficient to make to the optical fiber conform to a portion of the periphery of the pins.

Lateral load test—another bend test referenced herein is the lateral load test that provides a measure of the micro-bending resistance of the optical fiber. In this test, a prescribed length of optical fiber is placed between two flat plates. A No. 70 wire mesh is attached to one of the plates. A known length of optical fiber is sandwiched between the plates and the reference attenuation is measured while the plates are pressed together with a force of 30 newtons. A 70 newton force is then applied to the plates and the increase in attenuation and dB/m is measured. This increase in attenuation is the latter load attenuation of the optical fiber.

Transmission fiber/dispersion compensating fiber system—the relationship between a transmission fiber and a dispersion compensating fiber that completely compensates for the dispersion of the transmission fiber follows the general equation of:

D_{DC}(λ_{C})L_{DC}=−D_{T}(λ_{C})L_{T},

wherein DDC(λ_{C}) is the dispersion of the dispersion compensating fiber, L_{DC} is the length of the dispersion compensating fiber, D_{T}(λ_{C}) is the dispersion of the transmission fiber, λ_{C} is the center wavelength of the optical transmission band, and L_{T} is the length of the transmission fiber. This desired relationship of dispersion between the dispersion compensating fiber and the transmission fiber holds true for dispersion compensating fibers constructed of multiple compensation fibers.

The desired relationship of the κ of the optical fibers in a transmission line is as follows:

$${κ}_{DC} ( {λ}_{C} ) = \frac{{D}_{DC}}{{S}_{DC}} = {κ}_{T} ( {λ}_{T} ) = \frac{{D}_{T}}{{S}_{T}} ,$$

wherein κ_{DC} (λ_{C}) is the κ value for the dispersion compensating fiber, D_{DC} is the dispersion for the dispersion compensating fiber, S_{DC} is the dispersion slope for the dispersion compensating fiber, κ_{T} (λ_{T}) is the κ value for the transmission fiber, D_{T} is the dispersion for the transmission fiber, and S_{T} is the dispersion slope for the transmission fiber.

The desired relation between the κ values, the dispersion values and the dispersion slope values in a two-fiber compensating scheme, are defined by the equations:

$$\begin{matrix}\frac{{κ}_{SC}}{{κ}_{T}} = \frac{1 + X / {κ}_{T}}{1 + Y} \\ X = \frac{{L}_{FC} {D}_{FC}}{{L}_{T} {S}_{T}} \\ Y = \frac{{L}_{FC} {S}_{FC}}{{L}_{T} {S}_{T}} ,\end{matrix}$$

wherein the κ_{sc} is the κ value for the dispersion compensating fiber, κ_{T} is the κ value for the transmission fiber, L_{FC} is the length of the kappa compensating fiber, D_{FC} is the dispersion of the kappa compensating fiber, L_{T} is the length of the transmission fiber and S_{T} is the dispersion slope of the transmission fiber.

### SUMMARY OF THE INVENTION

In accordance with embodiments of the presents invention, a dispersion compensating fiber includes a segmented core having a refractive index profile a segmented core having a refractive index profile and a central core segment with a Δ₁% of greater than 2.0%, and a clad layer surrounding and in contact with the core and having a refractive index profile, wherein the refractive index profiles are selected to provide total dispersion at a wavelength of about 1550 nm of less than or equal to about −177 ps/nm/km, and a total dispersion slope at a wavelength of about 1550 nm of less than or equal to about −2.0 ps/nm/km. The refractive index profiles are further selected to provide a kappa value, defined as the total dispersion at 1550 nm divided by the dispersion slope at 1550 nm, of greater than or equal to about 67 nm. The fiber preferably has an effective area at a wavelength of 1550 nm of less than 12.0 μm².

In accordance with another embodiment of the invention, a dispersion compensating fiber includes a central core segment having a positive relative refractive index percent of less than or equal to about 2.7%, and an outer radius of within the range of from about 1.2 μm to about 1.5 μm, and a mote segment surrounding the central core segment and having a relative refractive index percent of greater than or equal to −0.9%, and width of within the range of from about 3.0 μm to about 3.7 μm. The dispersion compensating fiber further includes a ring segment surrounding the mote segment and having a relative refractive index percent of within the range of from about 0.5% to about 0.8%, and width of within the range of from about 1.5 μm to about 1.7 μm, and an outer clad surrounding the mote segment.

In accordance with yet another embodiment of the invention, an optical communication system includes an optical signal transmitter, an optical signal receiver, a transmission fiber in optical communication with the transmitter and the receiver, and having a positive dispersion and a positive dispersion slope, and a dispersion compensating fiber as is set forth above.

Additional features and advantages of the invention will be set forth in the detail description which follows, and in part will be readily apparent to those skilled in the art from that description or recognized by practicing the invention as described herein, including the detailed description which follows, the claims, as well as the appended drawings.

### BRIEF DESCRIPTION OF THE DRAWINGS

FIG. 1 is an isometric cross-sectional view of a novel optical waveguide embodying the present invention.

FIG. 2 is a diagram of a waveguide refractive index profile of an embodiment of the optical waveguide.

FIG. 3 is a diagram of a waveguide refractive index profile of a first example of the optical waveguide.

FIG. 4 is a diagram of a waveguide refractive index profile of a second example of the optical waveguide.

FIG. 5 is a diagram of a waveguide refractive index profile of a third example of the optical waveguide.

FIG. 6 is a diagram of a waveguide refractive index profile of a fourth example of the optical waveguide.

FIG. 7 is a diagram of a waveguide refractive index profile of a fifth example of the optical waveguide.

FIG. 8 is a diagram of a waveguide refractive index profile of a sixth example of the optical waveguide.

FIG. 9 is a diagram of a waveguide refractive index profile of a seventh example of the optical waveguide.

FIG. 10 is a graph of total dispersion versus wavelength for example fibers 1-7.

FIG. 11 is a graph of dispersion slope versus wavelength for example fibers 1-7.

FIG. 12 is a graph of the kappa value versus wavelength for example fibers 1-7.

FIG. 13 is a schematic diagram of a optical communication system employing the dispersion compensating fiber in accordance with the invention.

FIG. 14 is a graph of the residual dispersion versus wavelength for example fibers 1-6.

FIG. 15 is a diagram of a waveguide refractive index profile of an eighth example of the optical waveguide.

FIG. 16-18 are graphs of dispersion, dispersion slope, and kappa versus wavelength for example fiber 8.

### DETAILED DESCRIPTION OF THE PREFERRED EMBODIMENTS

For purposes of the description herein, it is to be understood that the invention may assume various alternative orientations and step sequences, except where expressly specified to the contrary. It is also to be understood that the specific devices and process illustrated in the attached drawings, and described in the following specification are exemplary embodiments of the inventive concepts defined in the appended claims. Hence, specific dimensions and other physical characteristics relating to the embodiments disclosed herein are not to be considered as limiting unless the claims expressly state otherwise.

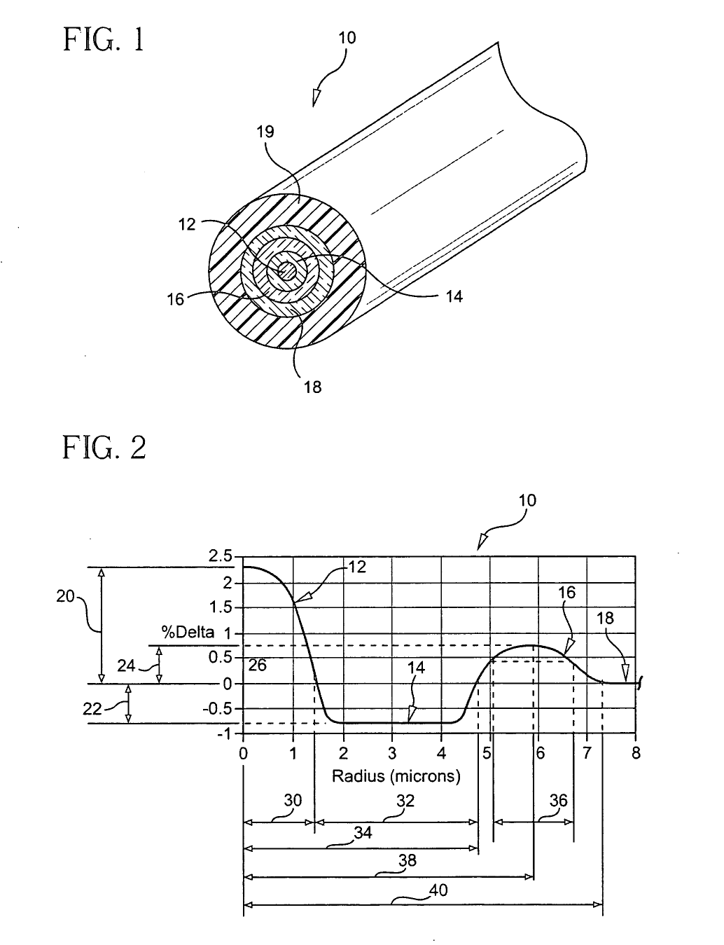

The optical waveguide compensating fiber described and disclosed herein has a generally segmented structure, as shown in FIG. 1. Each of the segments is described by a refractive index profile, a relative refractive index percent, Δᵢ, and an outside radius, rᵢ. The subscript i for the r and Δ refers to a particular segment. As shown in FIG. 2, the segments are numbered r₁, through r_{c} beginning with the innermost segment that includes the waveguide longitudinal axis center line. A clad layer having a refractive index of n_{c} surrounds the optical waveguide fiber. In the illustrated example, an optical waveguide compensating fiber 10 includes a central core segment 12 having an outer radius r₁, a depressed moat segment 14 having an outer radius r₂, an annular ring segment 16 having an outer radius r₃, a clad layer 18 having an outer radius r_{c}, and a UV curable polymer coating 19.

A general representation of the relative refractive index profile of compensating fiber 10 is illustrated in FIG. 2, which shows relative refractive index percent charted versus the compensation fiber radius. Although FIG. 2 shows only three discrete segments, it is understood that the functional requirements may be met by forming an optical waveguide compensating fiber having more than three segments. However, embodiments having fewer segments are usually easier to manufacture and are therefore preferred. Further, the fiber 10 may be constructed via a variety of methods including, but in no way limited to, vapor axial deposition (VAD), modified chemical vapor deposition (MCVD), plasma chemical vapor deposition (PCVD), and optical vapor deposition (OVD).

The central core segment 12 of fiber 10 has a relative refractive index percent 20, Δ₁% of preferably less than or equal to about 2.7%, and more preferably of within the range of from about 2.3% to about 2.7%. The central core segment 12 also has an outer radius 30 (r₁) preferably of less than or equal to 1.5 μm, and more preferably within the range of from about 1.2 μm to about 1.5 μm. The radius 30, r₁, is defined by the intersection of the profile of the central core segment 12 with the horizontal axis 26 corresponding with the profile of the cladding layer 18, which is preferably constructed of pure silica.

The depressed moat segment 14 of fiber 10 has a relative refractive index percent 22, Δ₂% of preferably greater than −0.8%, and more preferably of within the range of from about −0.8% to about −0.7%. The moat segment 14 also has a width 32 of preferably less than or equal to about 3.7 μm, and more preferably of within the range of about 3.0 μm to about 3.7 μm. The outer radius 34 (r₂) of moat segment 14 is the intersection of the moat segment 14 and the ring segment 16. In the illustrated example, the outer radius 34, r₂, is defined by the intersection of the profile of the moat segment 14 with the horizontal axis 26 corresponding with the profile of the cladding layer 18.

The annular ring segment 16 of fiber 10 has a relative refractive index percent 24, Δ₃% preferably of less than or equal to about 0.8%, and more preferably of within the range of from about 0.5% to about 0.8%. The ring segment 16 also has a half-height width 36 of preferably less than or equal to about 1.7 μm, and more preferably of within the range of from about 1.5 μm to about 1.7 μm, and has a center point radius 38 for the ring width 36 preferably of less than or equal to 6.3 μm, and more preferably of within the range of from about 5.8 μm to about 6.3 μm. The outer radius 40, r₃, of the ring segment 16 is the intersection of the ring segment 16 and the cladding layer 18.

The outer radius 40, r₃, of the ring segment 16 is also the inner radius of the cladding layer 18. The cladding layer 18 surrounds the ring segment and has a relative refractive index percent Δ_{c}% of approximately 0%, and an outer radius, r_{c} of about 62.5 μm.

The compensating fiber 10 of the present invention exhibits optical properties at a wavelength of about 1550 nm, including: preferred total dispersion of less than or equal to about −177.0 ps/nm-km, more preferably of greater than or equal to about −222.0 ps/nm-km, and most preferably of within the range of from about −177.0 ps/nm-km to about −222.0 ps/nm-km; preferred total dispersion slope of less than or equal to about −2.0 ps/nm²-km, more preferably of less than or equal to about −3.2 ps/nm²-km, and most preferably of within the range of from about −2.0 ps/²-km to about −3.3 ps/²-km; a preferred kappa value of greater than or equal to about 67.0 nm, more preferably of greater than or equal to about 87.0 nm, and most preferably of within the range of from about 67.0 nm to about 87.0 nm; preferred effective area of less than or equal to about 12.0 μm², more preferably of less than or equal to about 10.4 μm and most preferably of within the range of from about 10.4 μm² to about 12.0 μm²; preferred lateral load bend loss of less than or equal to about 0.57 dB/m, and more preferably of less than or equal to about 0.04 dB/m; preferred pin array bend loss of less than or equal to about 2.51 dB, and more preferably of less than or equal to about 0.16 dB; preferred mode field diameter of less than or equal to about 3.87 μm, more preferably of less than or equal to about 3.63 μm, and most preferably of within the range of from about 3.63 μm to about 3.87 μm. The compensating fiber 10 of the present invention further exhibits a preferred cutoff wavelength of greater than or equal to about 1810 nm, and more preferably of within the range of from about 1810 nm to about 1946 nm.

### EXAMPLE 1

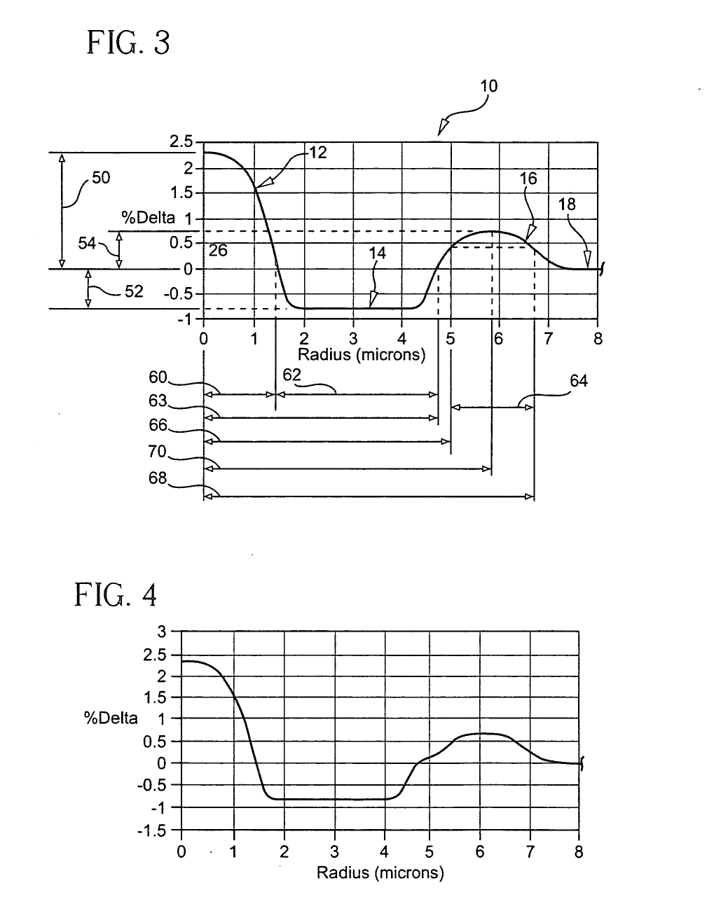

The diagram of FIG. 3 illustrates an example of the novel waveguide compensating fiber 10 that includes the central core segment 12, the depressed moat segment 14, the annular ring segment 16, and the outer clad 18.

The core segment 12 has a relative index 50, Δ₁% of about 2.311%, and an outer radius 60, r₁, of about 1.510 μm. The moat segment 14 has a relative refractive index 52, Δ₂% of about −0.825% and a width 62 of about 3.101 μm. The ring segment 16 has a relative refractive index 54, Δ₃% of about 0.965%, a width 64 of about 1.7 10, a radius for the inside half maximum height 66 about 5.000 μm, a radius for the outside half maximum height 68 of about 6.71 μm, and a radius for the ring center 70 of about 5.853 μm. The cladding layer has a relative refractive index, Δ_{c}% of about 0%, and an outer radius, r_{c} (not shown), of about 62.5 μm. The ratio of the outer diameter 60 of the core segment 12 to the outer diameter 63 of the moat segment 14, i.e., the core-moat ratio, is about 0.327. The alpha value for the fiber 10 of Example 1 is about 3.069. The optical properties of the compensating fiber 10 of FIG. 3, are given in Table 1.

TABLE 1
OPTICAL PROPERTIES FOR EXAMPLE FIBER 1

| | | | | | PIN | | |
|---|---|---|---|---|---|---|---|
| | | | | LAT. | ARRAY | | |
| | TOTAL | DISPERSION | | LOAD | BEND | EFFECTIVE | |
| WAVELENGTH | DISPERSION | SLOPE | | LOSS | LOSS | AREA | MFD |
| (NM) | (ps/nm/km) | (ps/nm²/km) | K (nm) | (dB/m) | (dB) | (μm²) | (μm) |
| 1550 | −177.5 | −2.12 | 83.6 | 0.04 | 0.16 | 11.40 | 3.79 |
| 1560 | −200.2 | −2.43 | 82.3 | — | — | — | — |
| 1570 | −226.1 | −2.73 | 82.8 | — | — | — | — |
| 1580 | −254.8 | −2.99 | 85.3 | — | — | — | — |
| 1590 | −285.7 | −3.14 | 91.1 | 1.00 | 3.90 | 14.53 | 4.11 |
| 1600 | −317.5 | −3.13 | 101.5 | — | — | — | — |
| 1610 | −348.2 | −2.87 | 121.3 | — | — | — | — |
| 1620 | −374.9 | −2.34 | 16.01 | — | — | — | — |

The compensating fiber 10 of FIG. 3 further provides a cutoff wavelength of about 1899 nm.

### EXAMPLES 2-7

The following Table 2 includes Examples 2-7 as shown in FIGS. 4-9, respectively, that define the physical parameters of a family of refractive index profiles of ore waveguides that yield the desired waveguide performance targets.

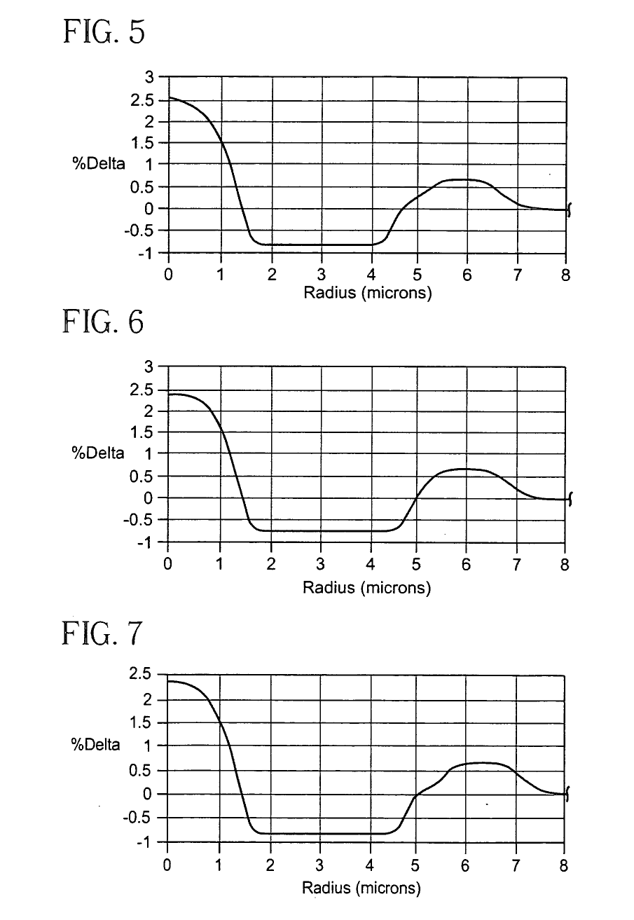

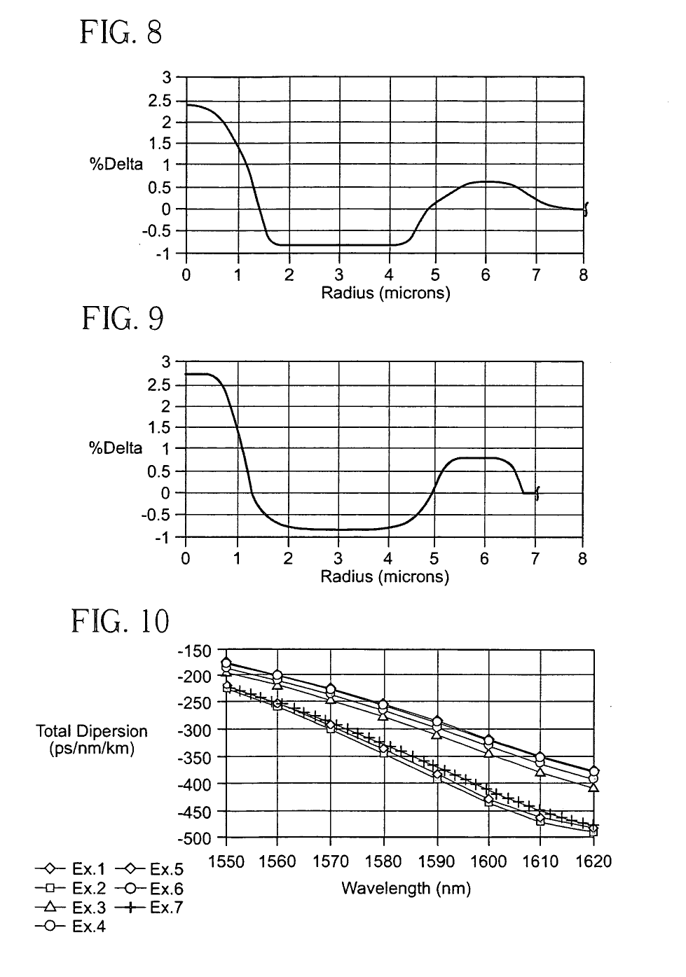

TABLE 2
PHYSICAL PARAMETERS FOR EXAMPLE FIBERS 2-7

| | Ex. 2 | Ex. 3 | Ex. 4 | Ex. 5 | Ex. 6 | Ex. 7 |
|---|---|---|---|---|---|---|
| | (FIG. 4) | (FIG. 5) | (FIG. 6) | (FIG. 7) | (FIG. 8) | (FIG. 9) |
| CENT. CORE Δ₁% | 2.355 | 2.564 | 2.388 | 2.326 | 2.462 | 2.700 |
| CENT. CORE RADIUS (μm) | 1.488 | 1.466 | 1.446 | 1.467 | 1.475 | 1.281 |
| MOAT SEGMENT Δ₂% | −0.851 | −0.804 | −0.719 | −0.743 | −0.717 | −0.800 |
| MOAT WIDTH (μm) | 3.057 | 3.030 | 3.391 | 3.351 | 3.198 | 3.659 |
| RING SEGMENT Δ₃% | 0.693 | 0.665 | 0.654 | 0.628 | 0.585 | 0.800 |
| RING CENTER RADIUS (μm) | 6.111 | 5.904 | 5.980 | 6.292 | 6.094 | 5.857 |
| RADIUS OF RING INSIDE | 5.300 | 5.075 | 5.230 | 5.130 | 5.440 | 5.072 |
| HALF MAXIMUM HEIGHT (μm) | | | | | | |
| RADIUS OF RING OUTSIDE | 6.91 | 6.72 | 6.95 | 6.85 | 7.15 | 6.641 |
| HALF MAXIMUM HEIGHT (μm) | | | | | | |
| RING WIDTH (μm) | 1.610 | 1.645 | 1.720 | 1.720 | 1.710 | 1.569 |
| ALPHA | 3.016 | 2.491 | 3.040 | 3.006 | 2.504 | — |
| CORE-MOAT RATIO | 0.327 | 0.326 | 0.299 | 0.305 | 0.316 | 0.259 |

The following Tables 3-6 set out the optical properties of the fiber Examples 2-7, as shown in FIGS. 4-9, respectively.

TABLE 3
DISPERSION VALUES FOR FIBER
EXAMPLES 2-7 (ps/nm/km)

| Wavelength | | | | | | |
|---|---|---|---|---|---|---|
| (nm) | Ex. 2 | Ex. 3 | Ex. 4 | Ex. 5 | Ex. 6 | EX. 7 |
| 1550 | −222.0 | −193.2 | −186.0 | −218.7 | −181.6 | −222.1 |
| 1560 | −257.4 | −217.7 | −209.5 | −253.6 | −203.8 | −251.8 |
| 1570 | −298.0 | −245.7 | −236.4 | −293.9 | −229.3 | −288.3 |
| 1580 | −342.8 | −276.9 | −266.5 | −338.5 | −257.9 | −328.9 |
| 1590 | −389.1 | −310.7 | −298.9 | −384.8 | −288.9 | −371.0 |
| 1600 | −432.6 | −345.3 | −332.3 | −428.2 | −321.3 | −412.0 |
| 1610 | −467.4 | −378.6 | −364.3 | −462.4 | −352.8 | −449.1 |
| 1620 | −487.5 | −407.3 | −391.7 | −481.2 | −380.8 | −479.7 |

TABLE 4
DISPERSION SLOPE VALUES FOR FIBER
EXAMPLES 2-7 (ps/nm²/km)

| WAVELENGTH (nm) | Ex. 2 | Ex. 3 | Ex. 4 | Ex. 5 | Ex. 6 | Ex. 7 |
|---|---|---|---|---|---|---|
| 1550 | −3.27 | −2.28 | −2.19 | −3.21 | −2.07 | −2.86 |
| 1560 | −3.80 | −2.63 | −2.52 | −3.76 | −2.39 | −3.32 |
| 1570 | −4.27 | −2.96 | −2.85 | −4.25 | −2.70 | −3.79 |
| 1580 | −4.54 | −3.24 | −3.12 | −4.54 | −2.98 | −4.13 |
| 1590 | −4.49 | −3.42 | −3.29 | −4.48 | −3.17 | −4.25 |
| 1600 | −3.88 | −3.38 | −3.27 | −3.88 | −3.19 | −4.03 |
| 1610 | −2.75 | −3.10 | −2.97 | −2.65 | −2.98 | −3.36 |
| 1620 | −0.99 | −2.43 | −2.34 | −0.88 | −2.46 | −2.11 |

TABLE 5
KAPPA (K) VALUES FOR FIBER EXAMPLES 2-7 (nm)

| WAVELENGTH (nm) | Ex. 2 | Ex. 3 | Ex. 4 | Ex. 5 | Ex. 6 | EX. 7 |
|---|---|---|---|---|---|---|
| 1550 | 67.9 | 84.6 | 85.0 | 68.1 | 87.6 | 77.8 |
| 1560 | 67.7 | 82.8 | 83.1 | 67.5 | 85.4 | 75.8 |
| 1570 | 69.8 | 83.0 | 83.0 | 69.2 | 84.8 | 76.1 |
| 1580 | 75.4 | 85.4 | 85.3 | 75.4 | 86.5 | 79.6 |
| 1590 | 86.7 | 90.9 | 90.8 | 85.8 | 91.2 | 87.2 |
| 1600 | 111.5 | 102.2 | 101.7 | 110.3 | 100.6 | 102.2 |
| 1610 | 170.2 | 122.2 | 122.8 | 174.4 | 118.5 | 133.9 |
| 1620 | 494.3 | 167.8 | 167.4 | 546.9 | 155.1 | 227.4 |

TABLE 6
ADDITIONAL OPTICAL PROPERTIES FOR FIBER EXAMPLES 2-7

| | EXAMPLE # | | | | | |
|---|---|---|---|---|---|---|
| | Ex. 2 | Ex. 3 | Ex. 4 | Ex. 5 | Ex. 6 | Ex. 7 |
| LAT. LOAD LOSS @ 1550 (dB) | 0.23 | 0.06 | 0.19 | 0.57 | 0.24 | 0.05 |
| LAT. LOAD LOSS @ 1590 (dB) | 2.92 | 1.13 | 1.89 | 5.62 | 2.14 | 0.17 |
| Pin Array Bend Loss | | | | | | |
| @ 1550 nm (dB/m) | 0.85 | 0.26 | 0.92 | 2.51 | 1.37 | 0.32 |
| @ 1590 nm (dB/m) | 8.46 | 4.79 | 8.72 | 18.19 | 11.54 | 3.30 |
| A_{EFF} @ 1550 NM (μm²) | 11.51 | 10.96 | 11.52 | 12.00 | 11.59 | 10.47 |
| @ 1590 NM (μm²) | 15.96 | 14.07 | 14.84 | 16.80 | 14.81 | 13.82 |
| MFD @ 1550 NM (μm) | 3.78 | 3.73 | 3.82 | 3.87 | 3.84 | 3.63 |
| MFD @ 1590 NM (μm) | 4.18 | 4.05 | 4.15 | 4.29 | 4.17 | 3.95 |
| λc (nm) | 1946 | 1874 | 1850 | 1907 | 1810 | 1933 |

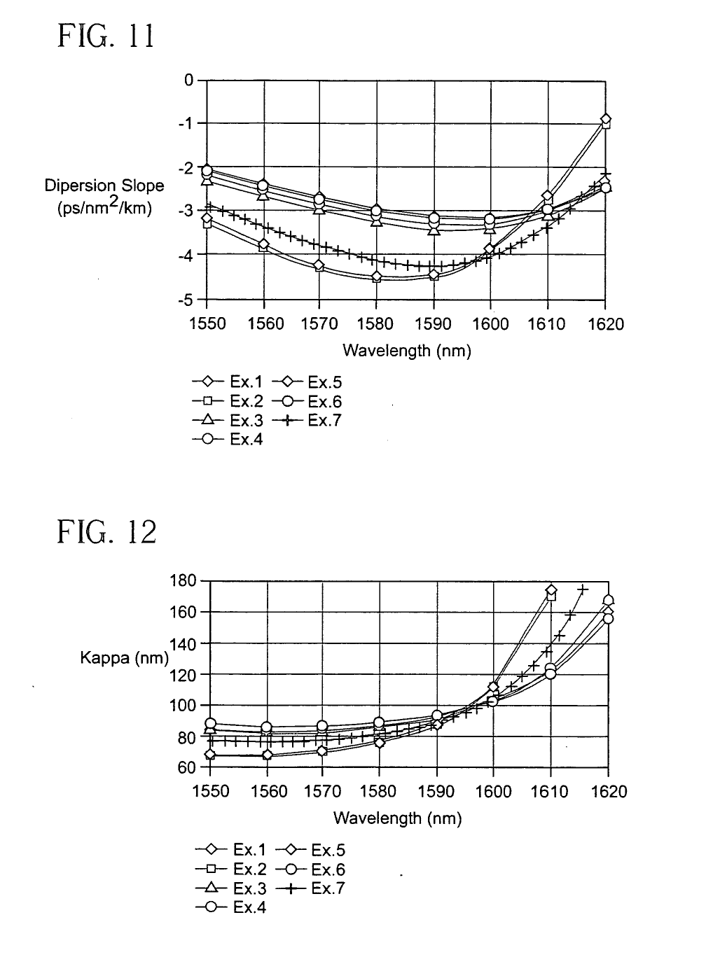

FIGS. 10-12 graph total dispersion, dispersion slope, and kappa value versus wavelength, respectively, for fiber Examples 1-7.

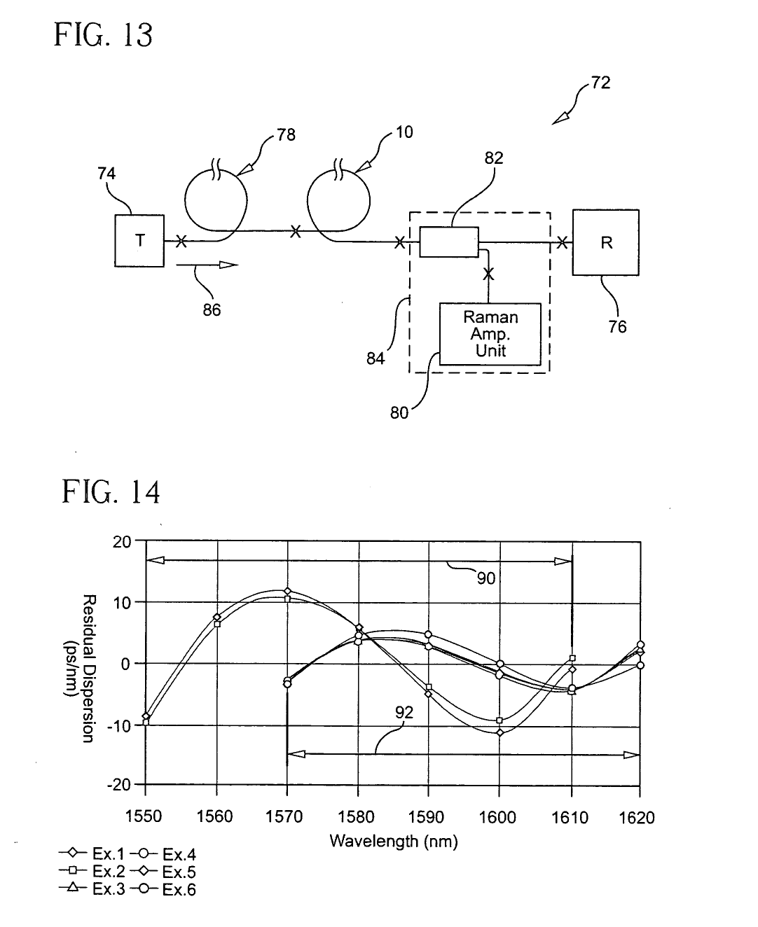

FIG. 13 illustrates a communication system 72 employing the dispersion compensating fiber 10 according to the embodiments described herein. The system 72 includes an optical signal transmitter 74, an optical signal receiver 76, and a transmission fiber 78 in optical communication with the transmitter 74 and the receiver 76. It should be recognized that the receiver and/or transmitter may optionally be a repeater. The transmission fiber 78 may be a non-zero dispersion shifted fiber (NZDSF) having positive dispersion and positive dispersion slope, for example.

Most preferably, the transmission fiber 78 is a single-mode optical fiber that has a refractive index profile providing a total dispersion between about 3.2 and 5.2 ps/nm/km at 1550 nm, a dispersion slope of between 0.063 and 0.107 ps/nm²/km at 1550 nm, a kappa between 37 and 62 nm, and an effective area at 1550 nm of greater than 60 μm². The dispersion compensating fiber 10 (which may be any of the aforementioned embodiments Ex. 1-7 shown in FIGS. 3-9) is coupled in optical communication with the transmission fiber 78.

Preferably, the system 72 includes a Raman amplification unit 80, and an optical coupler 82. The dispersion compensating fiber 10 may be wound onto a spool or reel and packaged in a common case or enclosure 84 with the Raman unit 80 as shown. Optionally, the dispersion compensating fiber 10 laid out (as opposed to winding on a spool) and therefore may contribute to the span length. As shown, the x's connote splices or connectors optically coupling the respective system components. In operation, the Raman unit is pumped and generates an amplification signal, which propagates counter to the signal direction shown by arrow 86 in the dispersion compensating fiber 10. Other common system structures including Raman amplification may be employed.

As should be recognized, the highly negative dispersion of the dispersion compensating fiber in accordance with the invention allows for the use of a much shorter lengths of dispersion compensating fiber. This has the distinct advantage of reducing the attenuation thereby reducing the cost of the module as well as reducing the amount of Raman power required. Further, the non-linear impairments in the system employing Raman pumping may be accordingly reduced. For example, a length of about 2-3 km of the dispersion compensating fiber in accordance with the invention may compensate for the built up dispersion of 100 km of the transmission fiber 78 described above. In addition, the residual dispersion amplitudes for such a system over the operating wavelength bands (preferably 1550 to 1610 nm or 1570 to 1620 nm) is less than 0.015 ps/nm/km. Table 2 below illustrates the residual dispersion amplitude over the Lambda Extreme and L bands. As should be apparent, some of the dispersion compensating fibers are designed to minimize system residual dispersion in either the Lambda Extreme or L band, but generally not both.

TABLE 7
RESIDUAL DISPERSION VALUES FOR SYSTEMS

| | | | RESIDUAL | |
|---|---|---|---|---|
| | | | DISPERSION | RESIDUAL |
| | | | LAMBDA | DISPERSION |
| | | | XTREME | L BAND |
| | L_{TRANS} | L_{DCF} | (1550-1610 NM) | (1570-1620 NM) |
| PARAMETER | (km) | (km) | (ps/nm/km) | (ps/nm/km) |
| EX. 1 | 100 | 2.625 | NA | 0.04 |
| EX. 2 | 100 | 1.945 | 0.11 | NA |
| EX. 3 | 100 | 2.415 | NA | 0.05 |
| EX. 4 | 100 | 2.51 | NA | 0.05 |
| EX. 5 | 100 | 1.97 | 0.12 | NA |
| EX. 6 | 100 | 2.59 | NA | 0.05 |
| EX. 7 | 100 | 2.04 | NA | 0.10 |

FIG. 14 illustrates plots of residual dispersion in ps/nm for a 100 km length of transmission fiber for some of the examples. As can be seen, the residual dispersion is less than 15 ps/km over the wavelength band of interest. For example, Ex. 1 and Ex. 5 are optimized for the Lambda extreme band and result in less than 15 ps/nm (0.15 ps/nm/km) over the range from 1550 to 1610 nm. Likewise, Ex. 1, Ex. 3, Ex. 4 and Ex. 6 are optimized for the L band and result in less than 10 ps/nm (0.1 ps/nm/km) over the range from 1570 to 1620 nm.

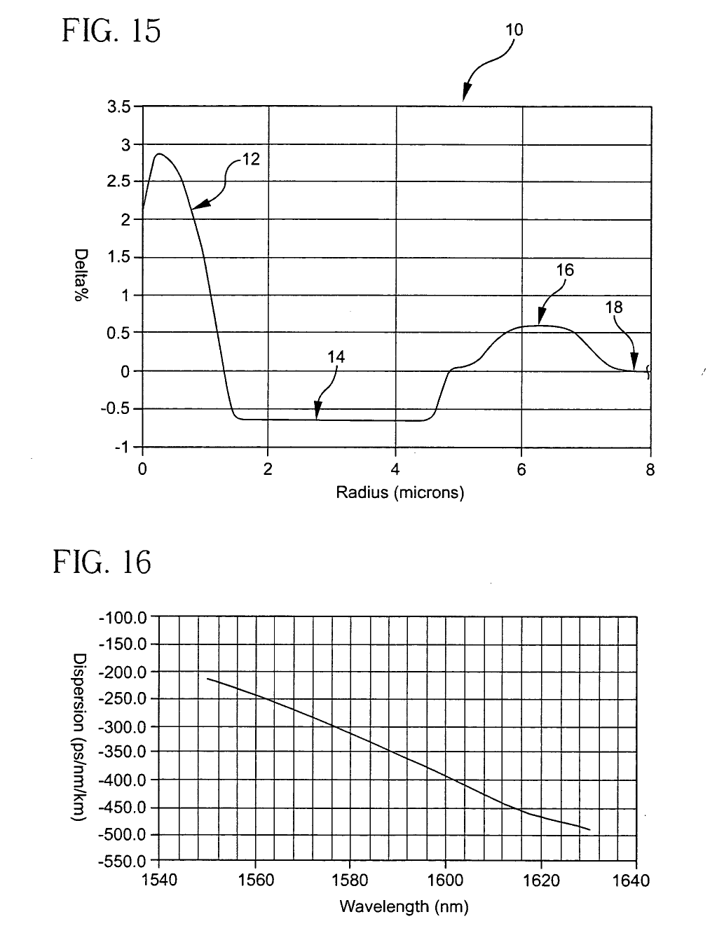

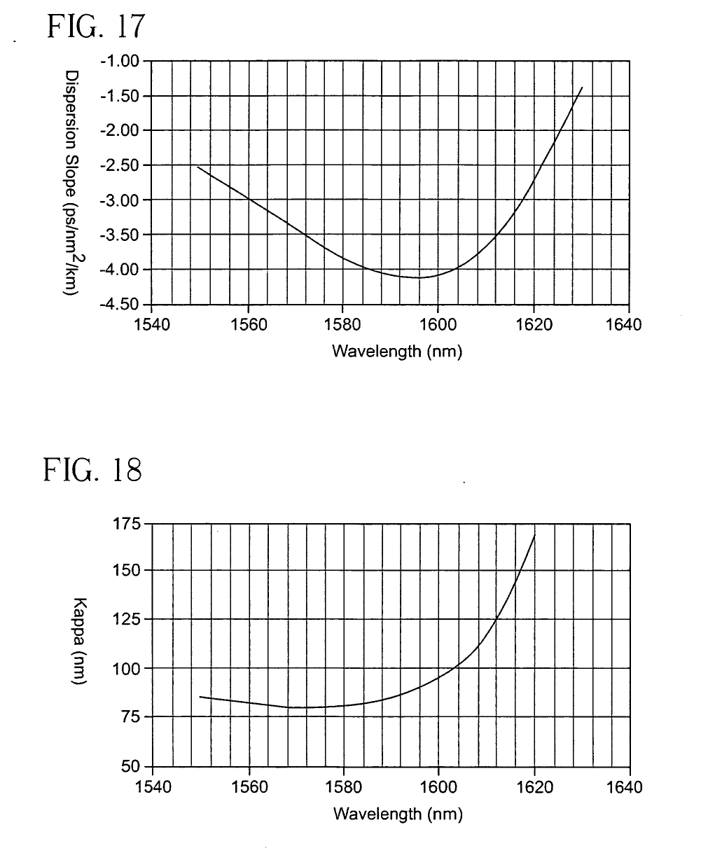

An additional profile of the dispersion compensating fiber 10 in accordance with the invention is shown in FIG. 15. This dispersion compensating fiber 10 also includes the central core segment 12, a moat segment 14, a ring segment 16, and a cladding 18 as heretofore described. The dispersion, dispersion slope, and kappa for this fiber Ex.8 are shown in FIGS. 16-18.

The properties and parameters of the profile Ex. 8 are described in Tables 8-9 below.

TABLE 8
PHYSICAL PARAMETERS FOR EXAMPLE FIBER 8

| | EX. 8 (FIG. 15) |
|---|---|
| CENT. CORE Δ₁% | 2.86 |
| CENT. CORE RADIUS (μm) | 1.275 |
| MOAT SEGMENT Δ₂% | −0.631 |
| MOAT WIDTH (μm) | 3.60 |
| RING SEGMENT Δ₃% | 0.628 |
| RING CENTER RADIUS (μm) | 6.275 |
| RADIUS OF RING INSIDE | 5.470 |
| HALF MAXIMUM HEIGHT (μm) | |
| RADIUS OF RING OUTSIDE | 7.080 |
| HALF MAXIMUM HEIGHT (μm) | |
| RING WIDTH (μm) | 1.610 |
| ALPHA | 2.567 |
| CORE-MOAT RATIO | 0.262 |

TABLE 9
OPTICAL PROPERTIES FOR FIBER EX. 8

| PARAMETER | EX. 8 |
|---|---|
| TOTAL DISPERSION | −214.7 |
| AT 1550 NM (ps/nm/km) | |
| TOTAL DISPERSION | −350.7 |
| AT 1590 NM (ps/nm/km) | |
| DISPERSION SLOPE AT 1550 NM (ps/nm²/km) | −2.53 |
| DISPERSION SLOPE AT 1590 NM (ps/nm²/km) | −4.09 |
| K (nm) AT 1550 NM | 84.9 |
| K (nm) AT 1590 NM | 85.8 |
| LAT. LOAD LOSS @ 1550 (dB) | 0.15 |
| LAT. LOAD LOSS @ 1590 (dB) | 1.90 |
| Pin Array Bend Loss | |
| @ 1550 nm (dB/m) | 0.66 |
| @ 1590 nm (dB/m) | 7.98 |
| A_{EFF} @ 1550 NM (μm²) | 10.63 |
| @ 1590 NM (μm²) | 13.87 |
| MFD @ 1550 NM (μm) | 3.68 |
| MFD @ 1590 NM (μm) | 4.03 |
| λc (nm) | 1933 |

It will be apparent to those skilled in the art that variations and modifications can be made to the present invention without departing from the spirit and scope of the invention. Thus, it is intended that the present invention cover the modifications and variations of this invention provided they come within the scope of the appended claims and their equivalents.

What is claimed is:

1. A dispersion compensating fiber, comprising:
a segmented core having a refractive index profile and a central core segment with a Δ₁% of greater than 2.0%;
a clad layer surrounding and in contact with the core and having a refractive index profile; and
wherein the refractive index profiles are selected to provide:
total dispersion at 1550 nm of less than −177 ps/nm/km;
total dispersion slope at a wavelength of 1550 nm of less than or equal to about −2.0 ps/nm²/km; and
a kappa value, defined as the total dispersion at 1550 nm divided by the dispersion slope at 1550 nm, of greater than or equal to 67 nm.

2. The fiber of claim 1 further comprising an effective area at 1550 nm of less than or equal to 12.0 μm².

3. The fiber of claim 1 wherein the total dispersion at 1550 nm is greater than about −222.0 ps/nm/km.

4. The fiber of claim 1 wherein the total dispersion at 1550 nm is within the range of from about −177.0 ps/nm/km to about −222.0 ps/nm/km.

5. The fiber of claim 1 wherein the total dispersion slope at 1550 nm is less than or equal to −3.20 ps/nm²/km.

6. The fiber of claim 1 wherein the total dispersion slope at 1550 nm is within the range of from −2.0 ps/nm²/km to about −3.3 ps/nm²/km.

7. The fiber of claim 1 wherein the wherein the kappa value at 1550 nm is greater than or equal to 87.0 nm.

8. The fiber of claim 1 wherein the wherein the kappa value at 1550 nm is within the range of from 67.0 nm to 87.0 mn.

9. The fiber of claim 1 wherein the effective area at 1550 nm is less than or equal to 10.4 μm².

10. The fiber of claim 1 wherein the segmented core includes a central core segment having a positive relative refractive index percent of less than or equal to about 2.7%.

11. The fiber of claim 10 wherein the central core segment has an outer radius of within the range of from 1.2 μm to 1.5 μm.

12. The fiber of claim 1 wherein the segmented core includes a moat segment surrounding and in contact with the central core segment the moat segment having a relative refractive index percent of greater than or equal to about −0.9%.

13. The fiber of claim 12 wherein the moat segment has a width of within the range of from 3.0 μm to 3.7 μm.

14. The fiber of claim 12 wherein the segmented core segment includes a ring segment surrounding an in contact with the moat segment and having a relative refractive index percent of within the range of from 0.5% to 0.8%.

15. The fiber of claim 14 wherein the ring segment has a width of within the range of from 1.5 μm to 1.7 μm.

16. The fiber of claim 15 wherein the width of the ring segment has a center point located within the range of from 5.8 μm to 6.3 μm.

17. An optical communication system, comprising:
an optical signal transmitter;
an optical signal receiver;
a transmission fiber in optical communication with the transmitter and the receiver, and having positive dispersion and positive dispersion slope; and
the dispersion compensating fiber as set forth in claim 1 in optical communication with the transmission fiber.

18. The optical communication system of claim 17 wherein a residual dispersion amplitude of the system over a wavelength range from 1550 to 1610 nm is less than 0.15 ps/nm/km.

19. The optical communication system of claim 17 wherein a residual dispersion amplitude of the system over a wavelength range from 1570 to 1620 nm is less than 0.1 ps/nm/km.

20. The optical communication system of claim 17 wherein the transmission fiber has a dispersion between about 3.2 and 5.2 ps/nm/km at 1550 nm, and a dispersion slope of between 0.063 and 0.107 ps/nm²/km at 1550 nm.
